(19) United States
(12) Patent Application Publication
(10) Pub. No.: US 2005/0011573 A1
(43) Pub. Date: Jan. 20, 2005

(54) Flexible liner air gap pipe

(75) Inventors: Paul Chahine, Dacula, GA (US); Peter H. Murray, Buford, GA (US); John G. Earl, Grass Lake, MI (US)

Correspondence Address: WOOD, HERRON & EVANS, LLP, 2700 CAREW TOWER, 441 VINE STREET, CINCINNATI, OH, 45202, US

(73) Assignee: American Boa, Inc., Cumming, GA (US)

(21) Appl. No.: 10/619,251

(22) Filed: Jul. 14, 2003

(51) Int. Cl. F16L 9/14

(52) U.S. Cl. 138/148; 138/134; 138/135; 138/114

(57) ABSTRACT

A multiple wall air gap pipe includes a rigid tube wall and at least one flexible tube wall defined by two or more overlapping profiles in wound, interlocking configurations. The multiple wall air gap pipe can be bent on conventional single wall pipe bending apparatus, inexpensively, while retaining the benefits of multiple wall air gap pipes.

This invention relates to conduits for transferring gas, liquid and solids and in particular in one application to exhaust gas conduits for internal combustion engines and for other applications where bending of air gap or multiple wall conduit is required.

### BACKGROUND OF THE INVENTION

In the past, it has been common to convey exhaust gas from an internal combustion engine of a vehicle, for example, to other components in the exhaust system and finally to a discharge end or tailpipe. Typically, rigid tubes of suitable material, gauge and diameter are used. For example, steel tubes or conduits of about 0.02 inches gauge to about 0.2 inches gauge and anywhere from one inch or less to twelve inches or more in diameter are used, though other parameters of exhaust pipes may be found.

In varied applications, it is desirable and, in many cases necessary, to orient the tubes or conduit in a tortious, curved or other path which is not straight. Thus, the axis of the tube in such application does not lie in a straight line, but varies from a straight line consistent with the particular application. For example, an exhaust pipe might be bent to lie in a curved path between an exhaust manifold and a catalytic converter or the entry end of a further exhaust pipe or exhaust system component. In another example, an exhaust pipe may define a bend as the pipe is routed over the rear axle of a vehicle.

In such applications, the rigid pipe is typically bent to a pre-determined shape or pattern with conventional bending apparatus and processes which form desirable bends without undesirable pipe deformations.

In certain exhaust applications, however, it is desirable to use a multiple wall exhaust conduit. Multiple wall or air gap pipes provide benefits such as reducing thermal loss of the medium transferred such as reducing heat transfer to the surrounding environment. Frequently, these comprise two rigid, concentric tubes, one within another, and an annular air gap therebetween. Bending techniques such as shot bending, hydroforming or other special techniques are required for bending such “air gap” pipes. Such bending techniques are typically expensive. And if the bending process is not carefully planned and monitored, the two component pipes can be crushed, folded, deformed or damaged in such a way as to render them unsuitable for an intended purpose.

Accordingly, it has been one objective of the invention to provide an improved, multiple wall, air gap pipe which can be bent using conventional single wall pipe bending techniques.

Another objective of the invention has been to provide an improved multiple wall rigid pipe which can be bent using conventional single wall pipe bending processes and which does not rely on the internal flexibility of the pipe material to accommodate bending in such processes.

### SUMMARY OF THE INVENTION

To these ends, one embodiment of the invention contemplates an air gap pipe which embodies the combination of a rigid wall pipe and an interior flexible pipe liner comprising at least one wrapped profile with cooperating edges movable with respect to each other. The flexible liner defines, with the rigid wall pipe, an air gap pipe which can be bent in conventional single wall pipe bending apparatus and processes. During bending, the wrapped profile of the flexible liner accommodates rigid pipe and liner bending without the need for hydroforming or other expensive bending processes for typical dual rigid wall air gap pipes.

Various profiles and wrapping configuration of flexible liners are contemplated in the invention, together with multiple liner walls, interior and exterior orientation of the flexible wall components, sizing and centering or positioning features, end features, free floating features, and varied simple and combined complex bends. These all provide multiple wall air gap pipes for varied application and which can be advantageously bent in conventional single wall pipe bending apparatus and processes.

Use of the combined rigid wall and flexible wall of selected profile facilitates tube bending, maintains concentricity, reduces pipe noise and vibration and allows for thermal expansion where heat is a factor. Thermal loss of transferring medium, together with heat transfer to the environment, is minimized, all while retaining these and other benefits of multiple wall air gap pipes and obtaining the capacity for bending in conventional single wall processes.

These and other objectives and advantages will become even more readily apparent from the following detailed description of the invention and from the drawings, in which:

### DETAILED DESCRIPTION OF THE DRAWINGS

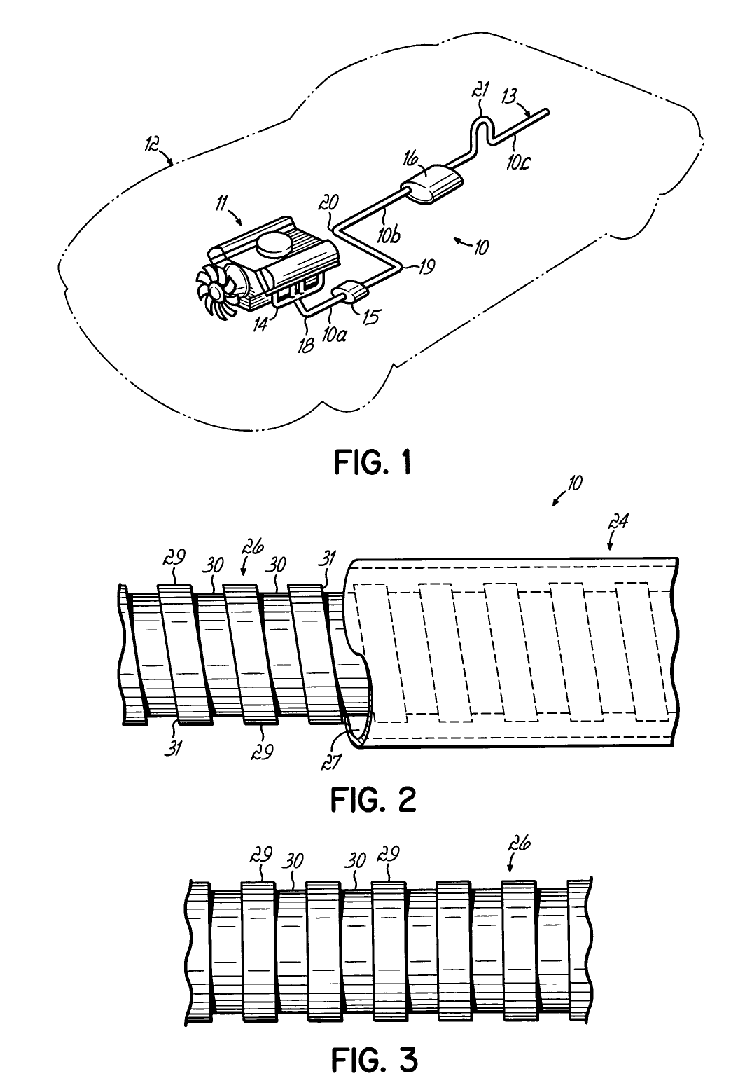

FIG. 1 is a perspective view illustrating an internal combustion engine and vehicle environment with which the invention can be used;

FIG. 2 is a side view in partially broken format showing an air gap pipe according to the invention;

FIG. 3 is a side view illustrating a liner tube wall of separating telescoping loops according to the invention;

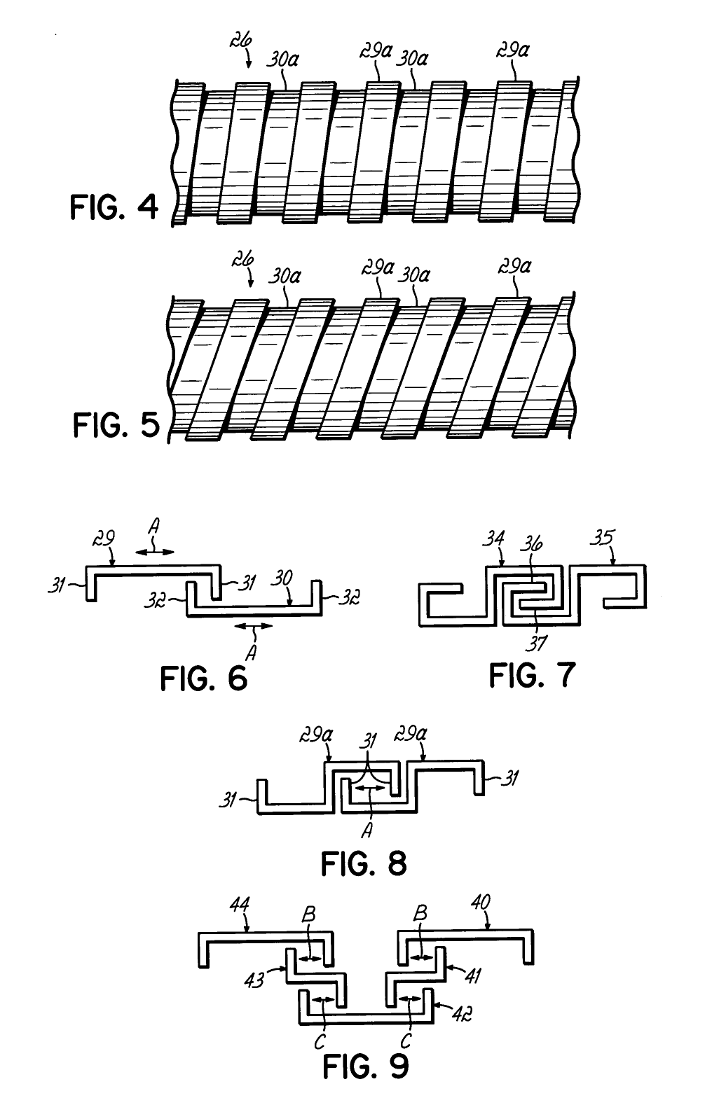

FIG. 4 is a side view illustrating a spiral wound liner according to the invention;

FIG. 5 is a side view illustrating a helical wound liner according to the invention;

FIG. 6 is a cross-sectional diagrammatic view illustrating an open, telescoping profile of a liner according to the invention;

FIG. 7 is a cross-sectional diagrammatic view illustrating a closed profile of a liner according to the invention;

FIG. 8 is a cross-sectional diagrammatic view similar to FIG. 6, but illustrating a sliding profile of a single strip according to the invention;

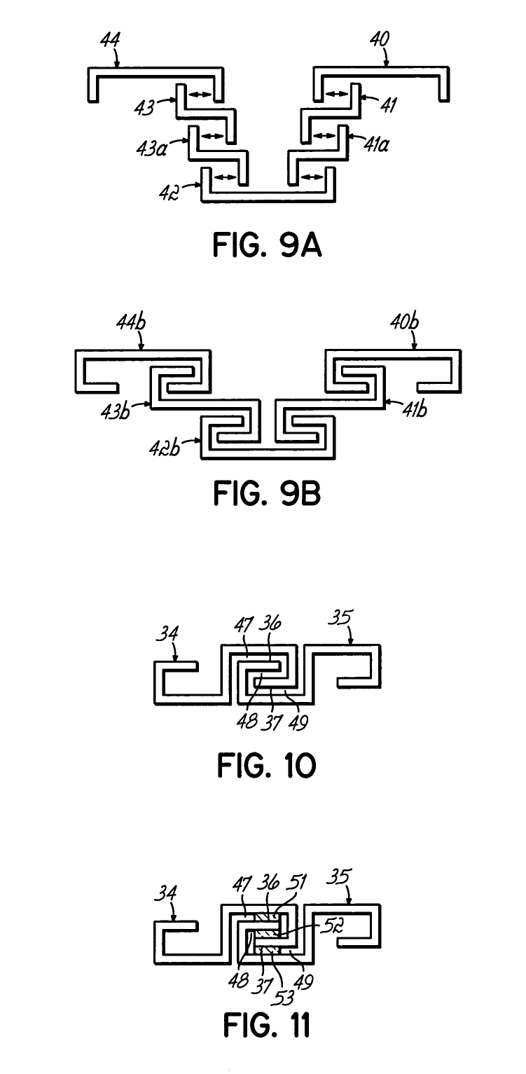

FIG. 9 is a cross-sectional diagrammatic view illustrating a multiple component sliding profile of a liner according to the invention;

FIG. 9A is a cross-sectional diagrammatic view similar to FIG. 9 but illustrating the use of more profiles in the liner;

FIG. 9B is a view also similar to FIG. 9 but showing multiple profiles of closed configuration in the liner;

FIG. 10 is a cross-sectional diagrammatic view illustrating a closed liner, without packing, according to the invention;

FIG. 11 is a cross-sectional diagrammatic view similar to file 11 but showing the liner profile with packing;

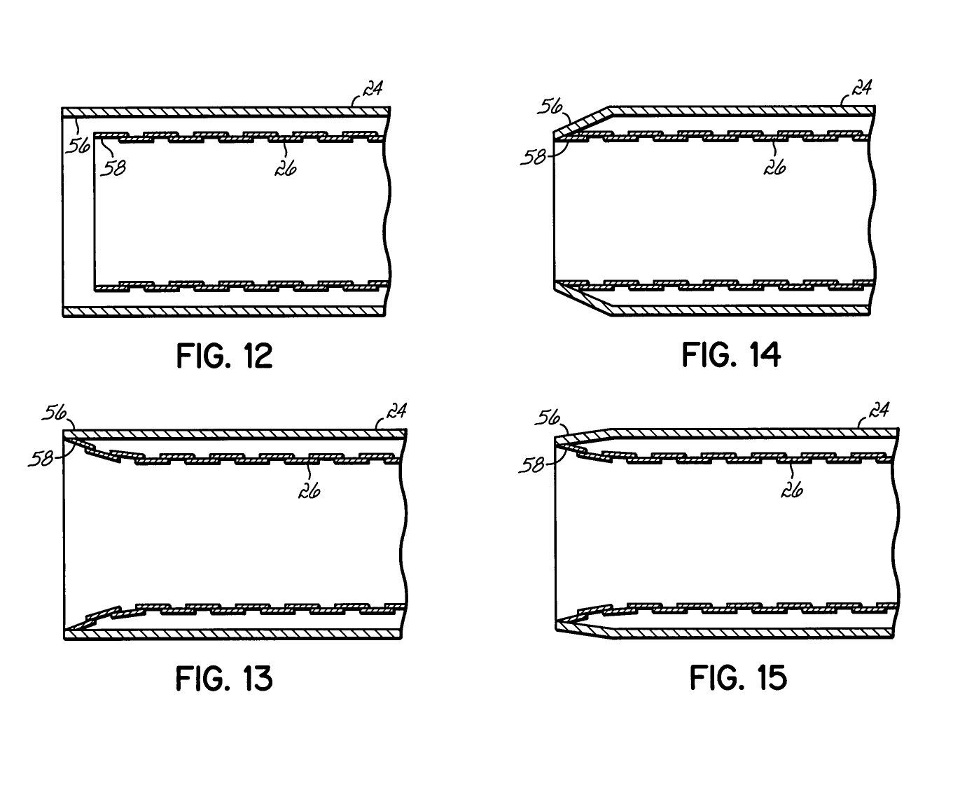

FIG. 12 is a diagrammatic side view illustrating a multiple wall air gap pipe with rigid outer tube and internally oriented flexible liner;

FIG. 13 is a view similar to FIG. 12 showing a liner with end sized to the outer tube;

FIG. 14 is a view similar to FIG. 12 showing an outer rigid tube with end sized to a liner;

FIG. 15 is a view similar to FIG. 13, 14 showing both tube and liner ends sized to each other;

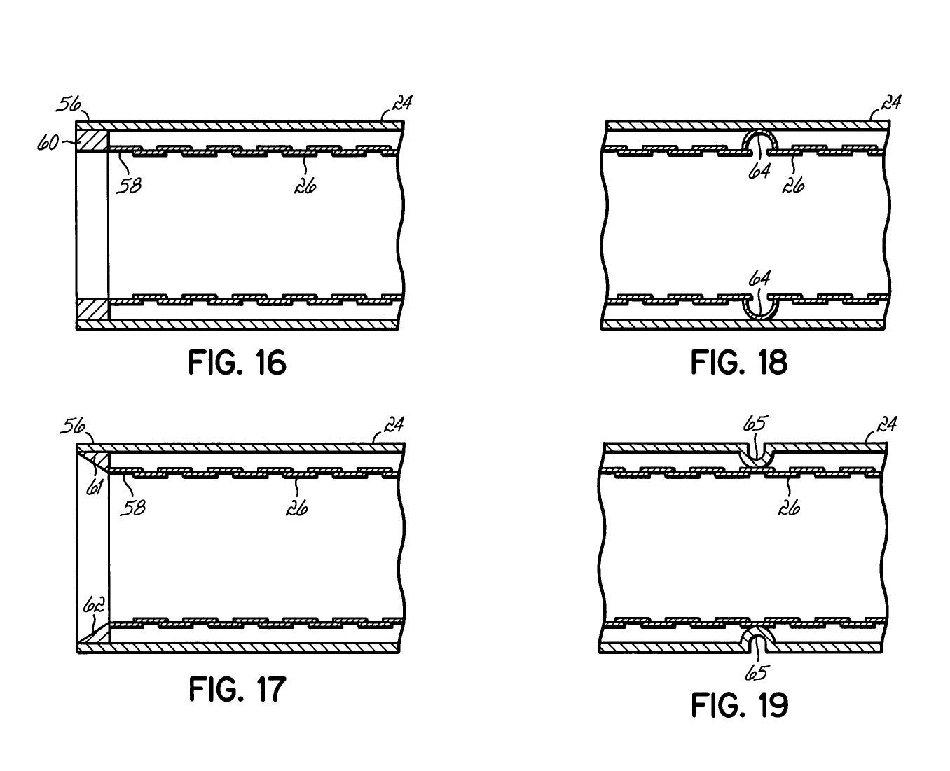

FIG. 16 is a view similar to FIG. 12 with an end ring joining the rigid tube and flexible liner;

FIG. 17 is a view similar to FIG. 16 but showing a formed or flared end ring joining the rigid tube and liner;

FIG. 18 is a diagrammatic side view illustrating a multiple wall air gap pipe with a flexible liner having an outwardly directed feature sized to center the liner in the outer rigid tube;

FIG. 19 is a diagrammatic side view illustrating a multiple wall air gap pipe with a rigid tube having an inwardly directed feature sized to support and center a flexible liner;

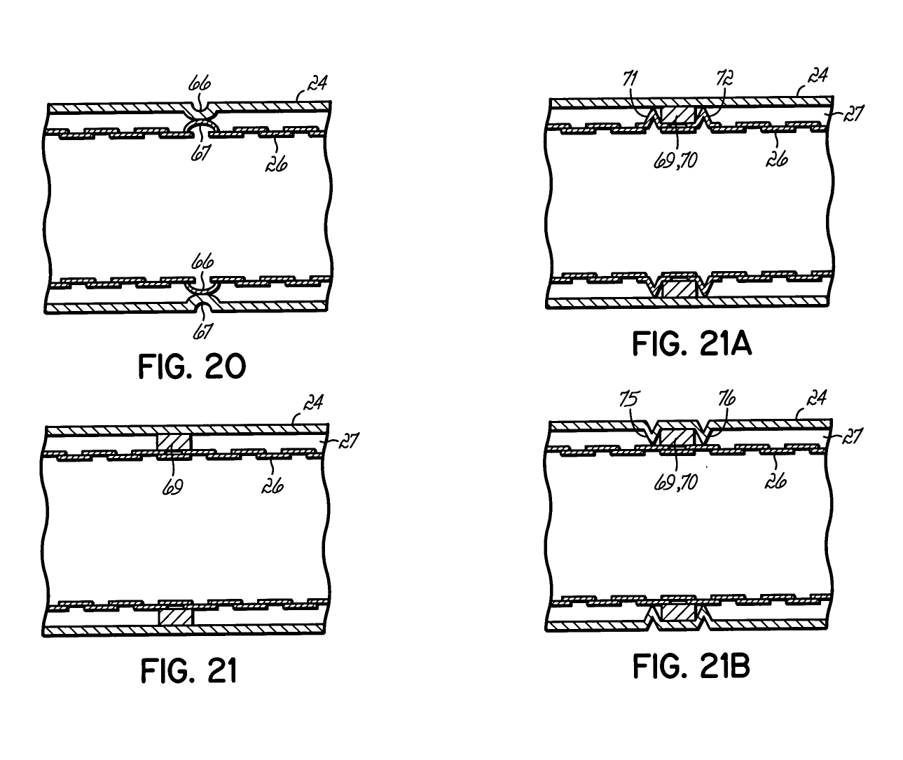

FIG. 20 is a diagrammatic side view illustrating a multiple wall air gap pipe with each of a rigid tube and flexible liner having locating features directed cooperatively toward each other for centering the liner in the tube;

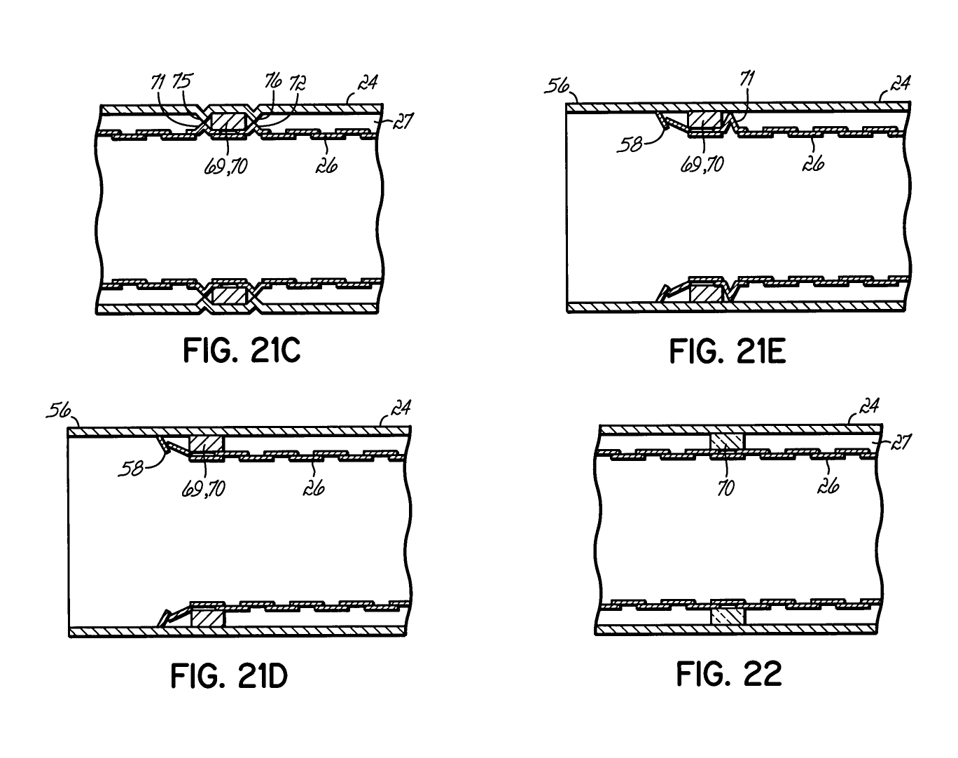

FIG. 21 is a diagrammatic side view illustrating a multiple wall air gap pipe and separate positioning components inserted between the rigid tube and flexible liner;

FIG. 21A is a view similar to FIG. 21 but showing a positioning member captured between two radial projections of a flexible liner of the invention;

FIG. 21B is a view similar to FIG. 21 but showing a positioning member captured between two radial projections from a rigid tube of the invention;

FIG. 21C is a view similar to FIG. 21 but showing a positioning member captured between opposite and cooperating radial projections from both a rigid tube and flexible liner of the invention;

FIG. 21D is a diagrammatic cross-sectional view illustrating disposition of a positioning member proximate the end of an air gap pipe according to the invention; and

FIG. 21E is a view similar to FIG. 21D but illustrating a captured positioning member proximate the end of an air gap pipe according to the invention.

FIG. 22 is a diagrammatic side view illustrating a multiple wall air gap pipe with separate ceramic components inserted between the rigid tube and flexible liner;

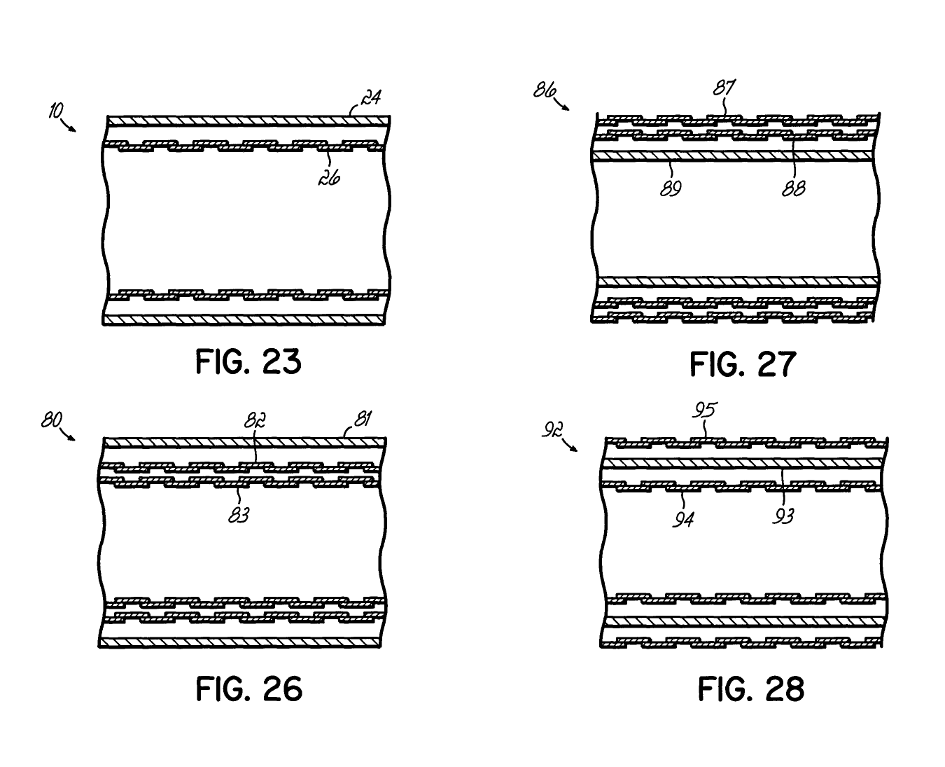

FIG. 23 is a diagrammatic side view illustrating a straight section of a multiple wall air gap pipe with a rigid outer tube and flexible liner according to the invention;

FIG. 24 is a view similar to FIG. 23 but showing an air gap pipe with a single bend;

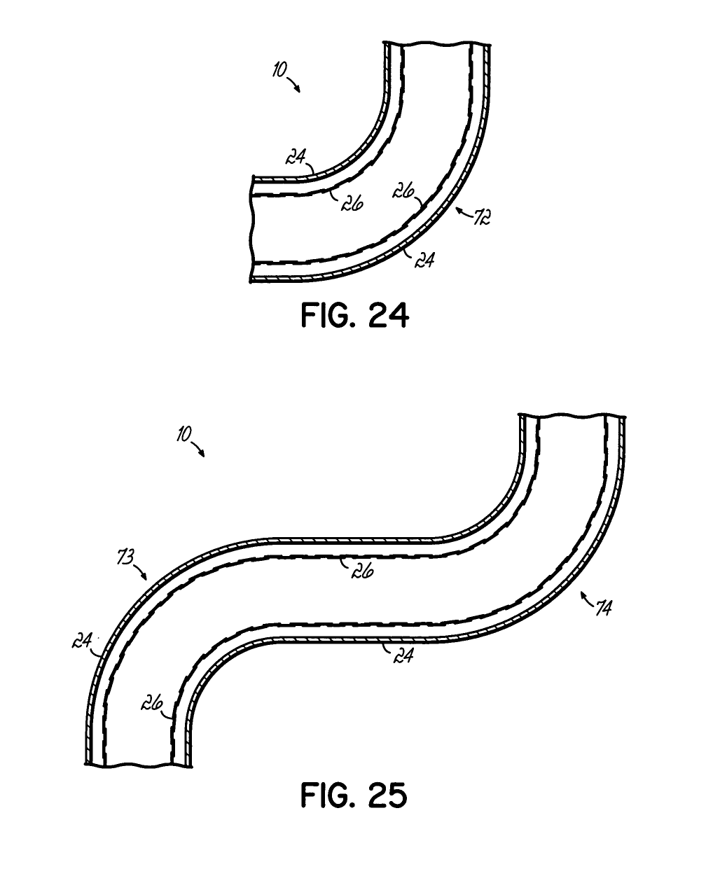

FIG. 25 is a view similar to FIG. 23 but showing an air gap pipe with a combination of bends;

FIG. 26 is a diagrammatic side view of a multiple wall air gap pipe illustrating a rigid outer tube with multiple inner flexible liners according to the invention;

FIG. 27 is a diagrammatic side view illustrating a multiple wall air gap pipe having a rigid tube with multiple outer flexible liners according to the invention;

FIG. 28 is a diagrammatic side view illustrating a multiple wall air gap pipe having a rigid tube with both inner and outer flexible liners according to the invention;

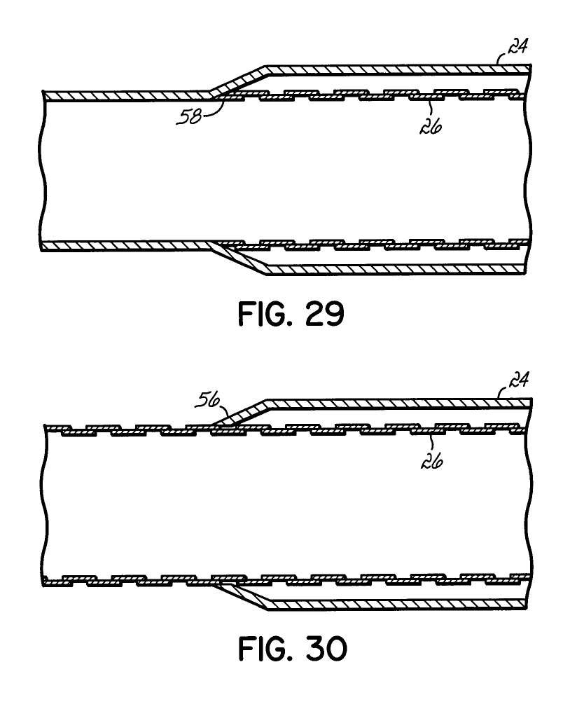

FIG. 29 is a diagrammatic cross-sectional view illustrating longitudinal extension of a flexible liner element from an air gap pipe of the invention; and

FIG. 30 is a diagrammatic cross-sectional view illustrating longitudinal extension of a rigid tube element from an air gap pipe of the invention.

### DETAILED DESCRIPTION OF THE INVENTION

Turning now to the drawings, it will be appreciated that the Figures are diagrammatic in nature. For example, FIGS. 6-11 simply illustrate only portions of cross-sections of the elongated profiles defining a flexible wall of the invention. And FIG. 12-30 show the flexible wall only diagrammatically, with the described and other alternative profiles possible.

There is illustrated in FIG. 1 one application of a flexible liner air gap pipe 10 according to the invention as applied to convey exhaust gas from an internal combustion engine 11 in a vehicle 12 to a tailpipe 13. One section 10a of pipe 10 runs from an exhaust manifold 14 to a converter 15. Another secton 10b of pipe 10 runs from converter 15 to muffler 16. Another section 10c of pipe 10 runs from muffler 16 to tailpipe 13. Each section 10a-10c is preferably of similar construction, although only a single such section of the exhaust system, according to the invention, with other forms of conduit serving to convey exhaust gas in other parts of the system, could be used. In a similar manner, various sections of pipe 10 may be constructed respectively according to different embodiments of the invention 10, as will be described. Tailpipe 13 could also have the same construction as pipe 10 or as any of the embodiments described herein, or it could be a single wall tube or any other form of tailpipe.

The application of the invention shown in FIG. 1 is illustrative only; the invention has multiple applications as will be appreciated for example, a multiple wall air gap 10, according to the invention, including its embodiments could be used between system flexible elements such as with decouplers, hoses and ball joints with resonators, or with connecting elements such as flanges, clamps and the like.

It will be appreciated from FIG. 1 that pipe 10 is in a straight configuration through a portion of the sections, while other portions are bent. In particular, section 10a has a bend 18 in a general upright or vertical plane, descending from manifold 14. Section 10b has two bends 19, 20 in generally horizontal disposition. Section 10c has a U-shaped bend 21 configured to clear a rear axle (not shown) of vehicle 12. These varied bends are mentioned to illustrate the capacity of a pipe 10, according to the invention, to accept single, combination and complex bends as may be desired in a gas exhaust or other application.

FIG. 2 illustrates details of a flexible liner air gap pipe 10 according to the invention. Pipe 10 includes a rigid tube defining a rigid wall 24 and a flexible liner comprising a flexible wall 26. When wall 26 is disposed internally of wall 24, an annular gap 27 is defined between the walls.

Preferably the tube defining wall 24 is made of any suitable material such as steel, in any suitable configuration such as in thickness ranging from about 0.02 inches to about 0.2 inches and any other suitable guage. Tube wall 24 may be of a diameter ranging from one inch or less to twelve inches or more, or of any other suitable diameter. Tube wall 24 is rigid with respect to flexible wall 26. And tube wall 24 can be of straight configuration of waffled, contoured or other shapes, or the like.

Flexible wall 26 is flexible and is easily bent, compared to wall 24. Flexible wall 26 can be defined by numerous elements or constructions and winding patterns according to varied embodiments of the invention. FIG. 6 illustrates one construction of flexible tube wall 26. In the embodiment of FIG. 6, wall 26 is defined by two elongated and overlapped flexible U-shaped strips or channels 29, 30 of metallic material, inverted with respect to each other and preferably steel or the like, or any suitable alloy or other material.

Channel 29 and channel 30 are disposed with at least edges overlapping, and are inverted with respect to each other as shown in the diagrammatic cross-sectional view of FIG. 6, the two channels being slidable with respect to each other in the direction of an arrow A. Respective channel flanges 31, 32 engage or abut to maintain the overlapping relation of the strips 29, 30. Such strips are wound, together, in an overlapping, telescoping loop, spiral or helical fashion to form an elongated tube wall 26. It will be appreciated that this wall is easily bent, the adjacent strips 29, 30 in the area of a bend, sliding relatively to each other so tube wall 26 can be bent. Flanges 32 are not visible in FIG. 2, being covered by strip 29.

Flexible tube wall 26 is disposed in one embodiment within rigid tube wall 24. This combined pipe 10 can be introduced to a conventional single tube wall bending apparatus and bent as desired. Such bends may take the form of bends 18, 19, 20 as illustrated in FIG. 1. When bent, rigid tube 24 takes the bend, while relatively flexible wall 26 bends along with tube wall 24 by virtue of the elongated flexible strips sliding, accommodating a very easy bend in flexible wall 26. Yet wall 26 may provide internal support for tube wall 24 in the bend areas, while maintaining an air gap 27 in air gap pipe 10 as shown.

Turning to FIGS. 3 through 5, it will be appreciated that the invention contemplates varied forms of flexible wall 26 of one or more strip of one or more separate finite lengths (29, 30) wraps in a telescoping, spiral or helical configuration, yet retaining the advantages of bending of pipe 10 in a conventional single tube bending apparatus. In the embodiment illustrated in FIG. 3, each strip 29, 30 is provided in separate loops, finite in length, about equal to the circumference each independent loop runs in, looping once about an interior or exterior surface of wall 24.

Thus, one loop of a strip 29 is laid over another separate loop of strip 30, and so on to define elongated flexible tube wall 26 by a plurality of separate strips. Each loop is discontinuous from each loop of a like strip, yet each separate loop telescopes over or under an adjacent loop to render tube wall 26 flexible. See a cross-section of such a flexible wall in FIG. 6, with an open configuration of separate loop strips 29, 30 or configurations of a flexible tube wall 26 illustrated in FIG. 4 wherein one elongated strip 29A of indeterminate lengths of channel-like profile is shown (see also FIG. 8). In this embodiment, the elongated strip 29A comprises a profile 29A like that of FIG. 8, wound on itself in a spiral fashion to form an open flexible tube wall 26. The strip 29a slides on itself in the direction of Arrow A (FIG. 8) to provide flexibility.

In yet another profile embodiment, shown in FIG. 5, two or more elongated strips 29B, 30B of indeterminate length are wound, not in separate loops but in overlapping helical fashion, onto each other to form a flexible tube wall 26. See FIG. 6 which is an illustrative cross-section of this configuration as well.

It will be appreciated that the strips in single loop configuration of FIG. 3 could be of varied profiles in the other shapes as shown. It will also be appreciated that varied profiles of multiple strips such as shown in FIGS. 6, 7 and 9-11 could be used in the looped, spiral or helical configurations of FIGS. 3-5.

Turning now to FIGS. 6 through 11, it will be appreciated that varied strip construction can be used to form flexible wall 26 as noted above. Elements of the various embodiments will be referred to by the same reference numbers as used with other embodiments. The FIG. 6 embodiment is described above, and is referred to as an “open” configuration. A similar but “closed” configuration is illustrated in FIG. 7. Here, strips 34, 35 are each “S”-shaped as shown. One flange 36 of strip 35 is intertwined with a flange 37 of strip 34. A flexible wall 26 can thus be formed of strips 34, 35 as shown where a tighter or more closed configuration is desired, yet there is sufficient room between the features of the respective strips 34, 35 so they can slide and provide a flexible tube wall 26. This profile, as well as others, can be looped or spiral or helical wound.

FIG. 8 illustrates the slidable range motion (arrow A) of a strip 29A in a single loop or indeterminate length spiral configuration.

FIG. 9 illustrates how slidable motion (arrows B & C,) can be provided within a flexible wall 26 when such wall is defined by multiple profiles such as the five elongated and overlapped strips 40 -44 shown. “Z”-shaped intermediate strips 41, 43 are interposed between U-shaped strips 40, 42 and 42, 44 respectively, to define, when wound together, a flexible wall 26. It will be appreciated that the “Z”-shaped profiles 43b, 41b, could be closed as in FIG. 9B, cooperating together with C-shaped profiles 44b, 40b and 42b, or that multiple “Z”-shaped profiles in excess of those in FIG. 9 could be used, as in FIG. 9A, such as at 43, 41, 43a and 41a.

FIG. 10 is similar to FIG. 7 and is provided to further demonstrate a flexible wall defining structure with gaps 47-49 between the inter turned flanges 36, 37 of respective overlapped strips 34, 35, and in either single looped, spiral or helical format. In FIG. 11, respective insulation or packing strips 51-53 are disposed in the respective gaps 47-49 to seal the strips so flexible wall 26, defined by intertwined and packed strips 34, 35, is gas-tight. Moreover, insulating or packing strips 51-53 reduce or increase friction between strips to reduce vibration and noise from a pipe 10 so constructed.

FIGS. 12-17 illustrate varied end constructions of pipe 10.

These can be used with the flexible tube walls 26 of the invention and of the varied embodiments. In FIG. 12, rigid wall 24 and flexible wall 26 are simply left to free float at their ends 56, 58. In FIG. 13, end 58 of flexible wall 26 is flared outwardly and attached to end 56 of wall 24, such as by contact or press fit, welding, brazing, etc. or any suitable process.

In FIG. 14, end 56 of rigid wall 24 is tapered inwardly, in frusto-conical shape, to end 58 of flexible wall 26 and is attached thereto by any appropriate technique.

In FIG. 15, end 58 of flexible wall 26 is flared outwardly to meet end 56, which is tapered inwardly of rigid wall 24. The ends are joined by any appropriate technique.

In FIG. 16, a ring 60 of any suitable material is secured to ends 56, 58 of respective rigid and flexible walls 24, 26. Ring 60 is disposed at ends 56, 58 or internally of the ends between walls 24, 26 as desired.

In FIG. 17, a ring 61 similar to ring 60 has an inner surface 62 flared outwardly, as shown. Ring 61 is disposed at or between ends 56, 58 as desired.

Moreover, FIGS. 29 and 30 illustrate how either the rigid tube wall 24 or the flexible tube wall 26 can extend beyond one another. In FIG. 29, flexible tube wall 26 extends beyond rigid tube wall 24 for interconnection, for example, to another component of a system. And in FIG. 30, rigid tube wall 24 extends beyond flexible tube wall 26 where that contraction is desirable. The two walls 24, 26 in FIGS. 29, 30 can be joined by any suitable technique such as brazing, welding, contact, press fit, etc.

Turning now to FIG. 18-22, there is illustrated therein varied positioning apparatus for orienting, sizing or centering one flexible tube wall 26 as described herein with respect to rigid tube wall 24.

In FIG. 18, flexible tube wall 26 is provided with a feature 64 extending radially outward from wall 26 to engage or contact, permanently or temporarily, rigid tube wall 24. Feature 64 can be an elongated strip wound into other strips defining wall 26. It can also be a continuous or intermittent radial extension or integral projection from a strip forming wall 26, or a member added onto or secured to one of the forming strips of wall 26. Features 64 can be opposed, as shown, or disposed in offset or spiral orientation. In any event, they extend outwardly to tube wall 24, sizing wall 26 thereto.

In FIG. 19, a feature 65 extends or projects radially inwardly from rigid tube wall 24 to flexible tube wall 26 sizing the elements together. Feature 65 can be rolled into tube 24, formed internally thereof by compression forming techniques when wall 24 is formed, or can be added as elements, opposed or in staggered relation.

In FIG. 20, opposed features 66, 67 extend radially toward and into engagement with each other to size walls 24, 26 together. Featue 66 can be formed similarly to feature 65 while feature 67 can be formed similarly to feature 64.

In FIGS. 21 and 22, centering elements are illustrated to center flexible tube wall 26 in rigid tube wall 24. A ring 69 is shown in FIG. 21, filling gap 27 between walls 24, 26 and centering flexible wall 26 within rigid wall 24. Ring 69 may be of metallic material. It can also be formed of woven wires, mesh, metallic matrices or any suitable material, such as a wire-formed damper cushion as made by the Buck Company of Columbia, S.C. And such cushions or positioning members may be welded or friction fitted or simply free floated in place.

In FIG. 22, a ceramic ring 70 is disposed in gap 27 between flexible wall 26 and rigid wall 24, centering wall 26 within wall 24.

FIGS. 21A-21E illustrate varied orientations or dispositions of a positioning member 69 or 70. In FIG. 21A, flexible tube wall 26 is provided with a profile having radial projections 71, 72 which capture elements 69 or 70.

In FIG. 21B, tube wall 24 has radially inward productions 75, 76 capturing positioning elements 69 or 70. In FIG. 21C, both rigid wall 24 and flexible wall 26 have respective projections 75, 76 and 71, 72 which extend toward each other and capture elements 69 or 70.

In FIG. 21D, an outwardly flared end 58 of flexible wall 26 captures an element 69 or 70. And in FIG. 21E, an outwardly flared end 58, together with a projection 71 captures a positioning element 69 or 70.

Of course, the radial extending projections 71, 72 and 75, 76 can extend inwardly or outwardly depending on the disposition of rigid wall 24 and flexible wall 26 as described in the Figures.

FIGS. 23-25 illustrate second bends which can be applied to a pipe 10 according to the invention. In FIG. 23, there is no bend; pipe 10 is useful in straight section. In FIG. 24, a single bend 72 is applied to pipe 10 by means of any suitable and conventional, single wall, rigid tube bending apparatus. Yet the advantages of a multiple wall air gap pipe are retained.

In FIG. 25, an air gap pipe 10 is provided with combined bends 73, 74 by any conventional single wall tube bender, yet while providing an air gap pipe.

Other bends of varied combinations, directions and in relative planes can be also so provided, including the U-shaped bend 21 of FIG. 1.

Finally, FIGS. 26, 27 and 28 demonstrate yet further embodiments of a multiple wall air gap pipe according to the invention. FIG. 26 illustrates an air gap pipe 80 defined by a rigid tube wall 81 (such as wall 24) and two internally disposed flexible tube walls 82, 83, one oriented within the other. Each wall 82, 83 can be made like wall 26 described above. The pipe 80 can also be bent on conventional single wall pipe bending apparatus, yet while providing the advantage of an air gap pipe with dual internal walls. Two or more flexible wall tubes, disposed internally of each other could be used.

FIG. 27 illustrates a multiple wall air gap pipe 86 wherein two flexible tube walls 87, 88 (each like wall 26) are disposed, one over the other, on the outside of a rigid tube wall 89 (like wall 24). This pipe 86 can be bent on conventional single tube bending apparatus like pipe 10, yet provides multiple wall air gap pipe performance. Two or more flexible walls could be disposed over each other in similar fashion to that shown.

FIG. 28 illustrates a multiple wall air gap pipe 92 according to the invention wherein a rigid tube wall 93 (like wall 24) is provided with an internal flexible tube wall 94 (tube wall 26) and an outer tube wall 95 (also like tube wall 26). Advantages of an air gap pipe so constructed as attained, but pipe 92 can be bent as conventional single tube bending apparatus. More than one flexible tube wall 93 or 94 could be used.

It will be appreciated that the various embodiments of features described herein are not mutually exclusive, but can be combined. Thus the positioning features of FIG. 18-22 for sizing or centering, for example, could be variously combined with a multiple number of rigid and flexible tube walls. The end constructions of FIG. 12-17 could be used with multiple wall air gap pipes of other Figures herein. The varied constructions of the flexible tube walls as illustrated in FIGS. 6-11 can be used in the pipes illustrated in the other Figures as desired, and for appropriate applications.

Moreover, varied profiles can be used in varied loops or winds or other relations to define the flexible tube wall 26. Also, the positioning members 69 or 70, for example, can be oriented and positioned as shown in the Figs. between the walls of an air gap pipe according to the invention where the walls are disposed as shown in the various configurations herein.

It will be appreciated that the invention in its various elements, features and combination thereof provides the advantages and benefits of a multiple wall air gap pipe, including minimization of medium thermal loss and heat transfer to the environment, all while attaining the benefits of easy pipe bending for useful applications in conventional, single wall tube bending apparatus.

These and other modifications and advantages will be readily appreciated by those of ordinary skill in the art without departing from the scope of this invention and the applicant intends to be bound only by the claims appended hereto.

1. A bendable, multiple wall air gap pipe apparatus comprising:
a rigid tube defining a rigid first wall;
at least one elongated profile member defining a flexible second wall;
said first and second walls having unequal diameters, one being disposed within the other;
said air gap pipe being bendable on conventional single wall tube bending apparatus.

2. Apparatus as in claim 1 wherein said flexible second wall is disposed within said first wall.

3. Apparatus as in claim 2 wherein said pipe has at least one bend of at least five degrees therein.

4. Apparatus as in claim 2 wherein said flexible second wall comprises at least two elongated profile members.

5. Apparatus as in claim 4 wherein said elongated profile members comprise elongated strips with overlapping edges.

6. Apparatus as in claim 5 wherein said edges are intertwined in multiple planes.

7. Apparatus as in claim 6 including packing members between intertwined edges.

8. Apparatus as in claim 5 further including at least three elongated profile strips with respective overlapping edges.

9. Apparatus as in claim 8 including at least seven elongated profile strips with respective overlapping edges.

10. Apparatus as in claim 5 wherein said edges are interlocked.

11. Apparatus as in claim 2 wherein said flexible second wall has an end flared outwardly toward an end of said first wall.

12. Apparatus as in claim 2 wherein said first rigid wall has an end constricted inwardly toward an end of said flexible wall.

13. Apparatus as in claim 2 wherein respective ends of said first and second walls are tapered toward one another.

14. Apparatus as in claim 2 further including a ring interconnecting respective ends of said first and second walls.

15. Apparatus as in claim 14 wherein said ring has a tapered surface.

16. Apparatus as in claim 2 wherein said flexible second wall includes a radially extending feature directed outwardly into engagement with said first wall.

17. Apparatus as in claim 2 wherein said first wall includes a feature directed radially inwardly to engagement with said flexible second wall.

18. Apparatus as in claim 2 wherein said first wall includes a feature directed radially inwardly toward said flexible second wall and said flexible second wall includes a feature directed radially outward toward said first wall, said respective features engaging to center said flexible second wall within said first wall.

19. Apparatus as in claim 2 further including metallic positioning members disposed between and separating said first wall from said flexible second wall and centering said flexible second wall within said first wall.

20. Apparatus as in claim 2 further including ceramic positioning members disposed between and separating said first wall from said flexible second wall and centering said flexible second wall within said first wall.

21. Apparatus as in claim 1 further including a positioning member disposed between said walls.

22. Apparatus as in claim 21 wherein said flexible second wall includes radially extending projections, said positioning member being disposed between said projections.

23. Apparatus as in claim 21 wherein said first rigid wall includes radially extending projections, said positioning member being disposed between said projections.

24. Apparatus as in claim 21 wherein each of said first rigid wall and said flexible second wall include radially extending projections projecting respectively toward each other in cooperating sets, and said positioning member being disposed between sets of said projections.

25. Apparatus as in claim 21 wherein said flexible second wall is flared outwardly to said rigid first wall and said positioning is disposed between said walls proximate said flexible second wall outward flare.

26. Apparatus as in claim 25 wherein said flexible second wall includes a radial projection proximate said outward flare, said positioning member being disposed between said outward flare and said radial projection.

27. Apparatus as in claim 2 wherein said pipe is straight.

28. Apparatus as in claim 2 wherein said pipe comprises at least one bend.

29. Apparatus as in claim 2 wherein said pipe comprises at least two bends.

30. Apparatus as in claim 1 wherein said pipe comprises a flexible third wall defined by at least one overlapping profile disposed within said flexible second wall.

31. Apparatus as in claim 1 wherein said pipe comprises a third flexible wall defined by at least one elongated profile member wrapped about an outer surface of said first wall.

32. Apparatus as in claim 31 wherein said flexible second wall is disposed within said first wall.

33. Apparatus as in claim 1 wherein said flexible second wall is disposed on an outer surface of said first wall and further including a flexible third wall defined by at least one elongated profile member having overlapping edges and being disposed on an outer surface of said flexible second wall.

34. Apparatus as in claim 1 wherein said first rigid wall extends longitudinally beyond said flexible second wall.

35. Apparatus as in claim 1 wherein said flexible second wall extends beyond said first rigid wall.

36. Apparatus as in claim 1 wherein said second wall is imperforate.

37. Apparatus as in claim 1 wherein said second wall has two ends and is spaced from said first wall throughout the length of said second wall between said ends.

38. Apparatus as in claim 1 wherein said second wall and said first wall each define respective tubes, said tubes being coaxial.
